(19) United States
(12) Patent Application Publication
(10) Pub. No.: US 2007/0065617 A1
(43) Pub. Date: Mar. 22, 2007

(54) System for the creation of laminated items

(76) Inventors: Albert Allen Dasher, Charlotte, NC (US); Gaylon K. Tustison, Cabot, AR (US)

Correspondence Address: J. CHARLES DOUGHERTY, 200 WEST CAPITOL AVE, SUITE 2300, LITTLE ROCK, AR, 72201, US

(21) Appl. No.: 11/230,211

(22) Filed: Sep. 19, 2005

(51) Int. Cl. B32B 33/00

(52) U.S. Cl. 428/40.1

(57) ABSTRACT

The invention is a system to allow the construction of identification cards and the like using standard office equipment such as an inkjet or laser printer and a laminating machine. The invention comprises successive layers of material that may be fed through a printer in one folded state, fed through a laminating machine in a second folded state, and the result being a two-sided laminated card, which may optionally include an embedded radio frequency identification (RFID) chip or other such items.

### BACKGROUND OF THE INVENTION

The present invention relates to the construction of laminated items, such as identity cards, key tags, and the like, and in particular relates to the construction of such an item that is easily produced with such equipment as is commonly found in most business offices.

Lamination has long been used to preserve and protect identification cards, labels, and the like. In the process typically employed, a card or other item is printed with the desired information. The card is then sandwiched between sheets of transparent, plastic lamination film and fed into a laminating machine. The laminate film typically extends past the edges of the card such that the laminate film sheets touch in a border around the card. The laminating machine heats the plastic laminate film as the card-film combination passes between steel rollers within the machine. As a result of the heat and pressure, the laminate film adheres to the card, and adheres to itself beyond the edges of the card. The result is a highly durable card that is resistant to water damage, stains, or aging.

Special problems are encountered with respect to the use of the technique described above for the production of identification cards and the like. Such cards typically require that information be printed on both sides. Conventional printers, such as the inkjet and laser printers found in most offices, cannot simultaneously print material on both sides of a card. Thus in order to print materials in this manner, the operator must print one side, re-feed the cardstock into the printer in the appropriate orientation, and then ensure that the printing on the opposite side matches the precise location of the printing on the first side. This process can be labor intensive and is prone to error.

Another complicating factor is that identification cards typically incorporate a photograph or other visual indicia of the person to whom the card is assigned for purposes of visual verification. The incorporation of a photograph into the printed card again complicates the task of printing such cards on a conventional office printer.

As a result of these difficulties, expensive, specialized equipment is typically employed to produce drivers licenses and other identification cards. Such systems are produced, for example, by Digimarc Corporation of Beaverton, Oreg. While such systems may prove cost-effective for the issuance of driver's licenses and other high-throughput applications, the cost of such systems makes them unfeasible for many institutions that might wish to issue identification cards to their customers in much lower numbers. Examples include libraries, museums, zoos, and retailers operating member discount programs. Such entities desire a means of producing high-quality, two-sided identification cards and the like using inexpensive equipment, and ideally would desire to use such equipment as may already be found in a typical office or bought off-the-shelf at general retail office and computer supply stores. Ideally, such cards could be produced on an as-needed basis, while the customer waits for the needed identification or other type of card. Some such entities would further desire a means of producing high-quality cards that include a radio frequency identification (RFID) chip, DNA sample, magnetic stripe, hologram, or other identification or information-bearing means, electronic or otherwise, to automate the reading and processing of personal identification or other applicable information when a card is presented or to provide further authentication when a card is presented.

### SUMMARY OF THE INVENTION

The present invention is directed to a laminated card kit or system that allows for the production of a one- or two-sided card or cards, including in some embodiments a photograph or other visual identification indicia, using only commonly available office equipment, such as an inkjet or laser printer and a laminating machine. The system requires only that printing be performed on one side of a printed sheet, but, if desired, may result in a two-sided card through a folding process. The present invention incorporates a printable surface, a board material to act as a carrier and stiffener, a lamination film, and various-adhesives in order to achieve these goals.

It is an object of the present invention to provide for a lamination card system that is easy to use with little training.

It is a further object of the present invention to provide for a lamination card system that allows for a high-quality printed card that is durable.

It is also an object of the present invention to provide for a lamination card system that does not require the purchase of expensive or customized printing and laminating equipment.

It is also an object of the present invention to provide for a lamination card system that allows for the production of laminated cards, particularly identification cards and the like, on demand as requested by the customer or other party to whom the card is issued.

It is also an object of the present invention to provide for a lamination card system that allows for the production of individually unique and secure identification and like cards.

It is also an object of the present invention to provide for a lamination card system to allow for the possibility of encapsulating radio frequency identification (RFID) chips or other identification or information-bearing means or items within or on the card.

These and other features, objects and advantages of the present invention will become better understood from a consideration of the following detailed description of the preferred embodiments and appended claims in conjunction with the drawings as described following:

### DRAWINGS

FIG. 1 is an exploded view of a preferred embodiment of the present invention.

FIG. 2 is a top plan view of a preferred embodiment of the present invention when folded for insertion into a printer.

FIG. 3A is a top plan view of a preferred embodiment of the present invention when fully unfolded.

FIG. 3B is a side elevational view of a preferred embodiment of the present invention, illustrating the manner in which the preferred embodiment is folded for insertion into a laminating machine.

### DETAILED DESCRIPTION OF THE PREFERRED EMBODIMENTS

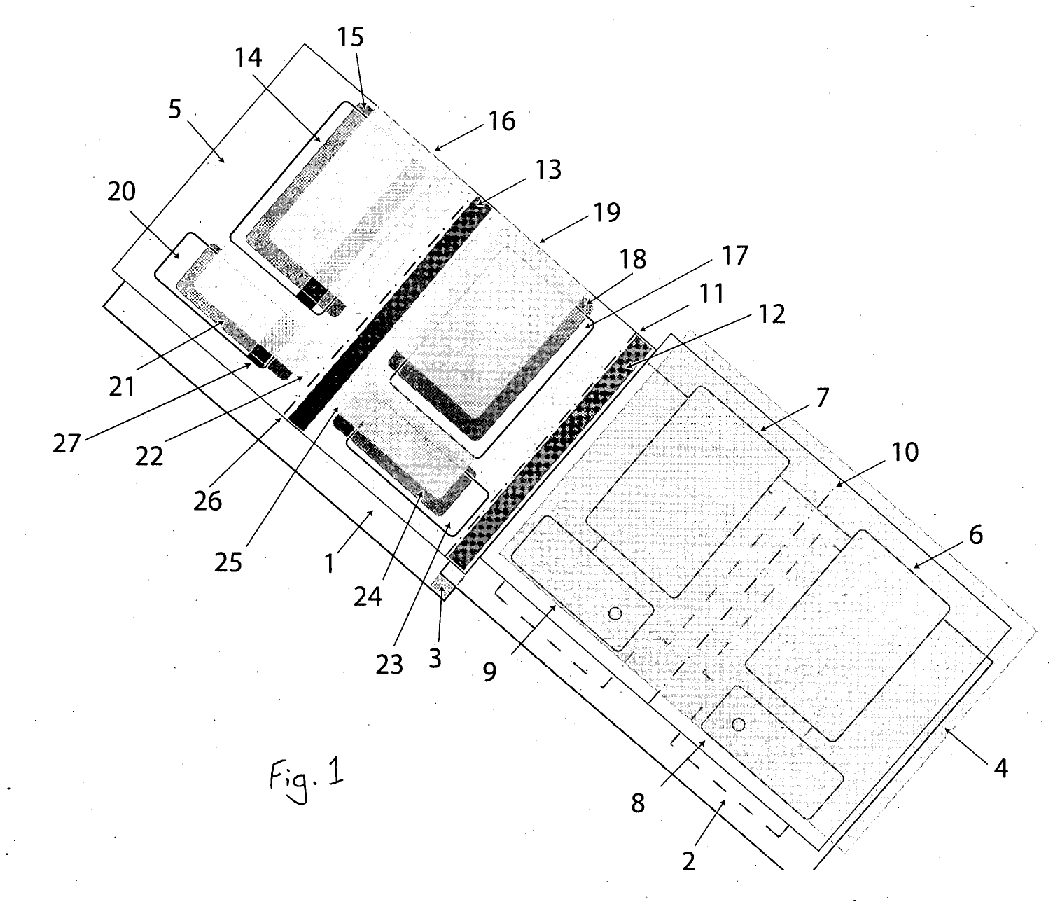

With reference to FIG. 1, a preferred embodiment of the present invention may now be described. As will be shown, the illustrative preferred embodiment shows the construction of a standard-sized identification card and a coordinated keychain ID tag. This is a common application, since full-size identification cards with matching key tags are often issued for identification purposes by many sorts of institutions. Any other form of identification means or other items could be constructed, however, using the basic techniques described herein, and the invention is not limited to this particular application. In particular, the invention is not limited to identification cards, or to two-sided cards, as it could be used with respect to any type of information-bearing card, whether such card is one- or two-sided. Furthermore, any number of items could, for example, could be constructed using alternative embodiments of the invention, depending upon the size of the items and the size of the media employed. This would allow for the production of multiple cards from a single sheet, such cards being identical or different, as called for by the particular application. In the illustrated preferred embodiment, the size of the media employed is four and fifteen-sixteenths by seven and three-fourths inches. Any other size could be used in alternative embodiments, provided it is acceptable to the printer and lamination machine to be employed.

Printable surface 2 is preferably a paper-like synthetic material capable of receiving ink from a standard office printer and bonding physically and chemically with hot lamination film. Such synthetic printable materials, or plasticized papers as they are sometimes known, are well known in the art. One manufacturer of such products is Duramic Inc. of Owensboro, Ky., which produces a material sold under the trade name Artisyn II. Any substitute material may be used that is capable of receiving printing and bonding to the appropriate components of the invention. One particular advantage of such materials as Artisyn II is that they allow the production of a laminated card that does not require lamination film to extend beyond the edges of the card. If standard paper is used, the lamination film must extend beyond the paper in order to seal the paper from moisture. In the preferred embodiment described herein, however, printable surface 2 using Artisyn II or a similar material forms a chemical and physical bond with the lamination coating. No edge seal is needed in order to protect printable surface 2 from moisture due to this seal and the water-resistant nature of Artisyn II and like materials. Another advantage of Artisyn II and like materials is that they produce excellent quality photographs even on conventional office printers.

During the manufacturing process for the preferred embodiment, one side of printable surface 2 is coated with an aggressive, dry-to-the-touch, heat-activated adhesive layer 4. One manufacturer of such an adhesive is Northwest Coating Corp. of Oak Creek, Wis. In alternative embodiments, any adhesive capable of bonding printable surface 2 to itself in a permanent fashion upon heating in a lamination machine may be used. The purpose of this adhesive layer 4 is to bond the two sides of the die-cut items to be formed from printable surface 2 (as will be described below) together. Any item that is to be encapsulated in the finished ID card, such as an RFID device or other electronic identification means (not shown), will be sandwiched between these two sides by bonding to printable surface 2 with adhesive layer 4 during a later part of the process. Various such devices as are known in the art may be included in the preferred embodiment.

Board 1 acts as a carrier for the lamination film as will be described herein. Board 1 thus allows the printable surface 2 and lamination film to be effectively bonded in most any commercially available lamination machine. During the manufacturing process for the preferred embodiment, board 1 is coated with release coating 5 as shown in FIG. 1. One manufacturer of such a release coating is Northwest Coating Corp. of Oak Creek, Wis. In alternative embodiments, any form of release coating 5 may be used that is sufficient to prevent board 1 from adhering permanently to the lamination film. It may be noted that a small strip of board 1 is not coated with release coating 5, near the overlap with printable surface 2, as shown in FIG. 1.

After the application of release coating 5, board 1 is coated with adhesive patches 14, 17, 20, and 23. The purpose of adhesive patches 14, 17, 20, and 23 is to temporarily adhere plastic lamination film patches 15, 18, 21, and 24, respectively, to board 1. On the back of lamination film patches 15, 18, 21, and 24 are permanent adhesive patches 16, 19, 22, and 25, respectively. Patches 15, 18, 21, and 24 may be constructed of any transparent lamination stock as is known in the art, preferably with the adhesive backing. The lamination film of the preferred embodiment is formed of polyethylene terephthalate (PET) material. Transilwrap Company Inc. of Franklin, Ill. is one manufacturer of the type of lamination film used for patches 15, 18, 21, and 24 in the preferred embodiment. This material includes a water barrier to prevent water from reaching printable surface 2; not all common lamination materials are in fact waterproof, as desired in the preferred embodiment.

Once adhesive patches 14, 17, 20, and 23 are added, adhesive strips 12 and 13 may be added to board 1. Adhesive strips 12 and 13 form a tacky, non-permanent bond; these adhesives are sometimes referred to as “fugitive” glues or adhesives, a well-known example being the glue used on Post-It brand notepads from 3M Corporation of Minneapolis, Minn. The purpose of adhesive strips 12 and 13 is to allow the invention to be folded and held in place during the printing and lamination processes. Permanent adhesive strip 3 is then added to the edge of board 1 as shown in FIG. 1, and board 1 is joined to printable surface 2 by adhesive strip 3 by slightly overlapping printable surface 2 to just cover adhesive strip 3 on board 1.

In the next step, lamination patches 15, 18, 21, and 24 are added to board 1 at adhesive patches 14, 17, 20, and 23. Following application of lamination patches 15, 18, 21, and 24, the die-cut portions of printable surface 2 may be formed. In the preferred embodiment, these are card front 6, card back 7, key tag front 8, and key tag back 9. Following typical die-cutting techniques, a small tab or tabs remain that connect the die-cut areas of printable surface 2 to the main body of printable surface 2 in order to prevent the die-cut areas from separating prematurely. It may be noted that the lamination patches 15, 18, 21, and 24, which are cut to generally conform to card front 6, card back 7, key tag front 8, and key tag back 9, respectively, are preferably cut completely from the stock in which they are formed. The left-over waste material from the lamination sheet used to form lamination patches 15, 18, 21, and 24 may be discarded.

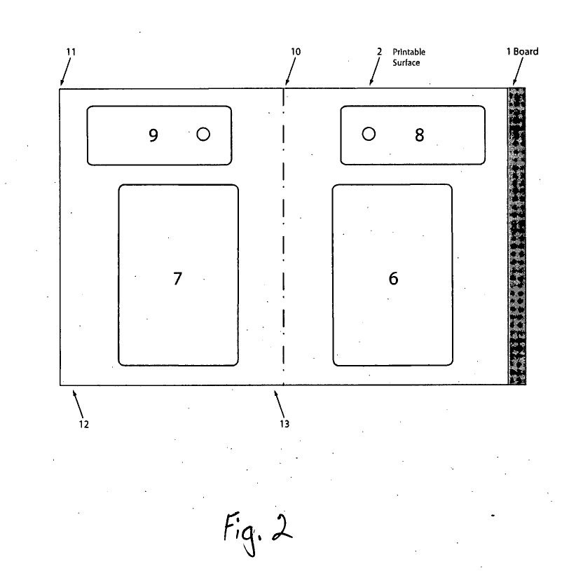

The last step of the assembly or manufacturing process of the preferred embodiment is to fold the preferred embodiment into the proper form for use in a customer printer. Printable surface 2 is folded over at perforation 11 to lie flat on top of board 1. It may be seen that adhesive strips 12 and 13 will hold board 1 against printable surface 2 until board 1 and printable surface 2 are pulled apart by the customer. The result from this folding operation is illustrated as FIG. 2.

The process for forming an identification card or other similar device according to a preferred embodiment of the present invention may now be described, with reference to FIGS. 1-3. While still folded such that board 1 rests under printable surface 2 and board 1 is held in place by adhesive strips 12 and 13 as shown in FIG. 2, the preferred embodiment may be inserted into a common office printer such that printable surface 2 is facing in the correct orientation in order to receive printed information. The information should be aligned such that it is received at the proper locations on the die-cut areas, that is, card front 6, card back 7, key tag front 8, and key tag back 9. Any information that may be printed using an office printer may be included, for example, not only wording but also bar codes, graphics, and photographs. Alternatively, photographs or other materials could be adhered to printable surface 2 along with the printed information as a separate item or items.

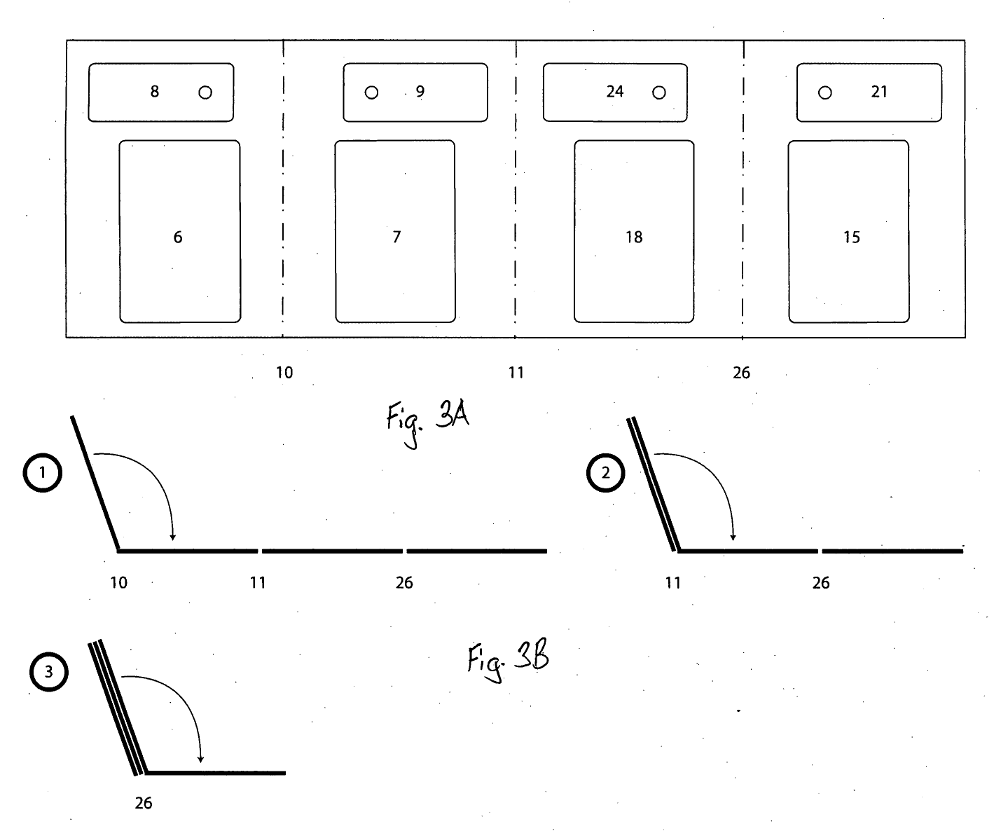

After printing is complete and the preferred embodiment is removed from the printer, the embodiment should be unfolded by removing board 1 from printable surface 2, as shown in FIG. 3A. Simply pulling board 1 away from printable surface 2 should cause adhesive strips 12 and 13 to release. At this point, an RFID chip, DNA sample, or any other identification indicia or item that the user may wish to insert in the finished identification card or key tag may be adhered to the appropriate die-cut areas of card front 6, card back 7, key tag front 8, and key tag back 9 at adhesive layer 4, on the side that is opposite the printed side of such areas.

To now prepare the preferred embodiment for lamination, the sequence of steps for such folding are illustrated at FIG. 3B. The preferred embodiment is first folded at perforation 10 such that the printed areas of printable surface 2 are turned to the outside, and the unprinted areas lie on the side of the fold facing each other. Adhesive layer 4 will thus be folded upon itself, and will adhere the two sides of the resulting card and key tag together once activated by the heat applied in the laminating machine. If an RFID chip or other item is included, then it will be trapped between the sides of the card or key tag once folded in this manner. Folding continues at perforation 11, such that the printed side of printable surface 2 is now aligned with lamination film patches 18 and 24. Finally, a third fold is made at perforation 26, such that the printed side of printable surface 2 is now aligned with lamination patches 15 and 21 on the side opposite of the side aligned with film patches 18 and 24. It may be seen that the film patches 15, 18, 21, and 24 are aligned with the die-cut portions of printable surface 2, card front 6, card back 7, key tag front 8, and key tag back 9.

The preferred embodiment may now be inserted into a standard commercial lamination machine. The heat and pressure of lamination will cause heat-activated adhesive layer 4 to bond the facing portions of printable surface 2 together, forming a complete card and key tag from card front 6, card back 7, key tag front 8, and key tag back 9. It will also cause film patches 15 and 18 to adhere to the resulting card, as well as causing film patches 21 and 24 to adhere to the resulting key tag.

After allowing the preferred embodiment to cool for a period after being removed from the laminator, preferably a period of thirty seconds, the preferred embodiment may be removed in order to form the final identification card and key tag. First the preferred embodiment is unfolded at perforation 26. A permanent bond will have formed between the printable surface 2 and film patches 15 and 21. Release coating 5 on board 1 results in the release of film patches 15 and 21 from adhesive patches 14 and 20, respectively, such that film patches 15 and 21 are removed from board 1 with them now being adhered to card front 6 and key tag front 8. Continuing the unfolding process at perforation 11 will result in the release of film patches 18 and 24 from board 1, since they are now permanently adhered to card back 7 and separate key tag back 9. The operator may now punch out the resulting card and key tag by breaking the small tabs holding the die-cut pieces to printable surface 2. The end result may be a separate card and key tag bonded between two sets of lamination, thereby reducing wear and protecting the resulting card and key tag, along with any RFID chip or other material that may be held within the two sides of the card or key tag.

It may be noted that in alternative embodiments of the invention security devices or features as are known in the art may be added to either printable surface 2 or to any of the lamination film patches 15, 18, 21, or 24. Such features could include, for example, holographic images. Likewise, a magnetic data stripe 27 containing or designed to contain encoded data could be added to one or more of film patches 15, 18, 21, or 24 in various embodiments, magnetic stripe 27 being illustrated in FIG. 1 as applied to film patches 21 and 15.

It should be noted that in the above description, certain steps in the manufacture or assembly of the preferred embodiment have been described as preceding in a certain order, but alternative embodiments may include these steps in any order as would allow the construction of the invention. If only a one-sided card is desired, certain folding steps may be skipped, as will be apparent from a review of the description above, and adhesive may be eliminated as would be necessary to bind the two sides of a card together. This approach would effectively double the number of cards that could be printed per sheet. Possible applications could be, for example, sports trading cards for children's sports teams or leagues. In addition, while the preferred embodiment is described for producing an identification card and key tag for a single person, single or multiple items for multiple different individuals could be combined onto the same sheet. Any such combination could be made within the limits of the size of sheet chosen and the printer and lamination machine available.

The preferred embodiment as described herein uses hot-melt adhesives and a heat-activation lamination machine in order to achieve the construction of the laminated items from the invention. It may be seen by one skilled in the art, however, that the invention could alternatively be realized using pressure-sensitive adhesive materials and the use of the lamination machine could in that manner be eliminated. The hot-melt lamination film is chosen for the preferred embodiment because it forms both a physical and chemical bond with printable surface 2.

The present invention has been described with reference to certain preferred and alternative embodiments that are intended to be exemplary only and not limiting to the full scope of the present invention as set forth in the appended claims.

We claim:

1. A system for the creation of one or more laminated items, comprising:
(a) a printable surface comprising a front side and back side, wherein said printable surface further comprises one or more pairs of matching print areas on said printable surface front side, and wherein said printable surface may be folded over with said printable surface front side facing outward such that matching pairs of said print areas are aligned with and facing outward from each other;
(b) a board comprising a front side and back side; and
(c) one or more lamination films releasably attached to said board front side, wherein when said printable surface is folded over with said printable surface front side facing outward such that matching pairs of said print areas are aligned, said printable surface may be positioned on said film such that one of said print areas is covered by one of said films, and said board and said printable surface may be folded together such that another of said print areas is covered by one of said films.

2. The system of claim 1, further comprising a heat-activated adhesive covering at least a portion of said printable surface back side opposite said print areas.

3. The system of claim 2, further comprising a release coating covering at least a portion of said board front side.

4. The system of claim 3, further comprising a releasable adhesive attaching said board front side to said one or more films.

5. The system of claim 4, further comprising a permanent adhesive covering at least a portion of said film at said film back side.

6. The system of claim 1, further comprising at least one fugitive adhesive strip at said board front side.

7. The system of claim 6, wherein said board and said printable surface each comprise an edge, and wherein said board and said printable surface are connected at about their respective edges.

8. The system of claim 7, wherein said board and said printable surface are connected by overlapping their edges and applying a permanent adhesive between their edges.

9. The system of claim 8, further comprising a first fugitive adhesive strip and a second fugitive adhesive strip, wherein said first fugitive adhesive strip is positioned at about said board edge and said second fugitive adhesive strip is positioned at about a position of a fold formed whereby said board and said printable surface may be folded together such that said print areas are each covered by one of said films.

10. The system of claim 1, wherein said print areas comprise a plurality of die-cut areas on said printable surface.

11. The system of claim 10, further comprising a number of lamination films equal to the number of said die-cut areas and each said lamination film corresponding to one of said die-cut areas, and wherein said lamination films comprise a size and shape approximately the same size as said corresponding die-cut area.

12. The system of claim 11, wherein said die-cut areas comprise the shape of one or more of an identification card and a key tag.

13. The system of claim 12, further comprising an item fitted between corresponding die-cut areas said printable surface when said printable surface is folded over such that said printable surface front side is facing outward with matching pairs of said print areas aligned and facing outward from each other.

14. The system of claim 13, wherein said item comprises one of a radio frequency identification (RFID) chip and a DNA sample.

15. The system of claim 11, wherein at least one of said lamination films comprises a magnetic data stripe.
